(19) United States
(12) Patent Application Publication
(10) Pub. No.: US 2015/0072246 A1
(43) Pub. Date: Mar. 12, 2015

(54) NON-AQUEOUS LIQUID ELECTROLYTE FOR SECONDARY BATTERY AND NON-AQUEOUS SECONDARY BATTERY

(71) Applicant: FUJIFILM Corporation, Tokyo (JP)

(72) Inventors: Yohei ISHIJI, Kanagawa (JP); Michio ONO, Kanagawa (JP)

(73) Assignee: FUJIFILM CORPORATION, Tokyo (JP)

(21) Appl. No.: 14/542,883

(22) Filed: Nov. 17, 2014

Related U.S. Application Data
(63) Continuation of application No. PCT/JP2013/063355, filed on May 14, 2013.

(30) Foreign Application Priority Data
May 18, 2012 (JP) 2012-114329

(51) Int. Cl. H01M 10/0567; H01M 4/131; H01M 4/48; H01M 10/0525

(52) U.S. Cl. CPC H01M 10/0567; H01M 10/0525; H01M 4/131; H01M 4/48; H01M 2004/028
USPC 429/324

(57) ABSTRACT

A non-aqueous liquid electrolyte for a secondary battery, the non-aqueous liquid electrolyte containing an electrolyte, an organic typical metal compound and an organic solvent, the organic solvent containing the electrolyte and the organic typical metal compound, the organic typical metal compound being contained in the organic solvent in an amount of 1 mol/L or less.

### CROSS-REFERENCE TO RELATED APPLICATIONS

This application is a Continuation of PCT International Application No. PCT/JP2013/063355 filed on Mar. 7, 2013, which claims priority under 35 U.S.C. §119 (a) to Japanese Patent Application No. 2012-114329 filed on May 18, 2012. Each of the above applications is hereby expressly incorporated by reference, in its entirety, into the present application.

### FIELD OF THE INVENTION

The present invention relates to a non-aqueous liquid electrolyte for a secondary battery, and a non-aqueous secondary battery.

### BACKGROUND OF THE INVENTION

Secondary batteries called lithium ion batteries are currently attracting attention. They can broadly be classified into two categories of so called lithium ION secondary batteries and lithium METAL secondary batteries. The lithium ION secondary batteries utilize storage and releasing of lithium in the charge-discharge reaction. Besides, the lithium METAL secondary batteries utilize precipitation and dissolution of lithium in the charge-discharge reaction. These batteries both can realize charge-discharge at large energy densities as compared with lead batteries or nickel-cadmium batteries. By making use of this characteristic, in recent years, these batteries have been widely applied to portable electronic equipment such as camera-integrated VTR's (video tape recorders), mobile telephones, and notebook computers. So as to respond to further expansion of applications as to a power source of the portable electronic equipment, the development has been continually progressed to provide lightweight secondary batteries with higher energy densities. Nonetheless, there exists a strong demand for size reduction, service life prolongation, and safety enhancement.

Regarding a liquid electrolyte to be used in lithium ion secondary batteries or lithium metal secondary batteries (hereinafter, these may be collectively referred to simply as a lithium secondary battery), a particular combination of materials has widely been employed in order to realize high electric conductivity and potential stability. That is, a carbonic acid ester-based solvent like propylene carbonate or diethyl carbonate is employed, in combination with an electrolyte salt of lithium hexafluorophosphate or the like.

With respect to the composition of a liquid electrolyte, for the purpose of improving battery characteristics, technique is variedly proposed as to additives to be contained in a liquid electrolyte. For example, by the additives, it is proposed to form an oxidative polymerized film as a protective film (SEI: Surface Electrolyte Interface) on the negative electrode (see Patent Literatures 1 and 2). Besides, it is also attempted to form such a protective film in the positive electrode as revealed in Patent Literatures 3 and 4.

### CITATION LIST

### Patent Literatures

Patent Literature 1: JP-A-2003-15162 (“JP-A” means unexamined published Japanese patent application)
Patent Literature 2: JP-A-2003-031259
Patent Literature 3: Japanese Patent No. 3787923
Patent Literature 4: JP-T-2008-538448 (“JP-T” means searched and published International patent application)
Patent Literature 5: JP-A-01-206571

### SUMMARY OF THE INVENTION

### Problems that the Invention is to Solve

In view of the above-described current situation in this technical field, the present inventors were in pursuit of search and research on ingredient compositions of the functional liquid electrolyte. More specifically, the present invention thus addresses to the provision of a non-aqueous liquid electrolyte which can allow an improvement in cycling characteristics of a non-aqueous secondary battery by combining selection of additives to be contained in the liquid electrolyte and a tiny amount of blend thereof. Further, the present invention addresses to the provision of a secondary battery using the non-aqueous liquid electrolyte.

### Means to Solve the Problem

There has been known an example that a metallocene which is typified by ferrocene is used as an additive for the non-aqueous secondary battery (the above-described Patent Literature 5). However, this has been recognized as a redox shuttle agent, but it has not been known that this forms a positive electrode-protective film. As a result of in-depth consideration, the present inventors have nevertheless found that an organic typical metal compound such as a metallocene compound and the like can considerably react on a positive electrode surface, containing a particular active material, thereby to exhibit an effect brought by which a protective film may supposedly be formed on the surface thereof. The present invention has been completed on the basis of such technical findings.

The above-described problems of the present invention were solved by the following means.

[1] A non-aqueous liquid electrolyte for a secondary battery, the non-aqueous liquid electrolyte comprising:

an electrolyte;

an organic typical metal compound; and

an organic solvent, the organic solvent containing the electrolyte and the organic typical metal compound, the organic typical metal compound being contained in the organic solvent in an amount of 1 mol/L or less.

[2] The non-aqueous liquid electrolyte for a secondary battery as described in the item [1], wherein the organic typical metal compound is a compound represented by the following formula (I):

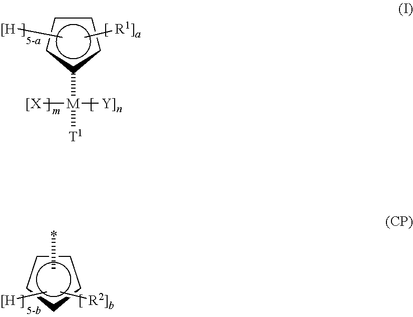

wherein M represents a typical metal element; R¹ represents an alkyl group, an alkenyl group, an alkynyl group, an alkoxy group, a thioalkoxy group, an amino group, an alkylamino group, an amide group, an acyloxy group, a cyano group, a carboxyl group, a group containing a carbonyl group, a group containing a sulfonyl group, a phosphinyl group, or a halogen atom; R¹ may form an aliphatic ring or an aromatic ring;

a represents an integer of from 0 to 5;

X and Y each independently represent an alkyl group, an alkoxy group, a thioalkoxy group, an alkylamino group, a sulfonate group, a halogen atom, an aryl group, or a heteroaryl group;

m and n are integers satisfying 0≦m+n≦3;

T¹ represents a hydrogen atom, a methyl group, a n-butyl group, an alkylamino group, or a group represented by formula (Cp); R² in formula (Cp) has the same meaning as R¹; * means an atomic bonding; b represents an integer of from 0 to 5; and R¹ and R² may be linked to each other.

[3] The non-aqueous liquid electrolyte for a secondary battery as described in the item [2], wherein the compound represented by formula (I) is a compound represented by the following formula (Icp):

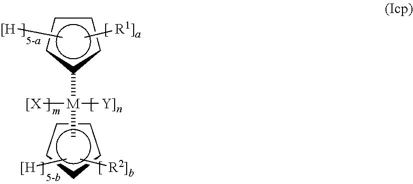

wherein M, R¹, R², a, b, X, Y, m and n have the same meanings as those in formula (I).

[4] The non-aqueous liquid electrolyte for a secondary battery as described in the item [1], wherein the organic typical metal compound has a partial structure represented by formula (II):

M-NR³R⁴ formula (II)

wherein M represents a typical metal element; N represents a nitrogen atom; R³ and R⁴ each independently represent a hydrogen atom, an alkyl group, an alkenyl group, an alkynyl group, an aryl group, a heteroaryl group, an alkylsilyl group, or a halogen atom; R³ and R⁴ may form an aliphatic ring or an aromatic ring; and R³ and R⁴ may be linked to each other.

[5] The non-aqueous liquid electrolyte for a secondary battery as described in the item [4], wherein R³ and R⁴ each are an alkyl group or an alkylsilyl group.
[6] The non-aqueous liquid electrolyte for a secondary battery as described in the item [4], wherein the compound represented by formula (II) is a compound represented by the following formula (IIa) or (IIb):

M-(NR³R⁴)_{q} formula (IIa)

(NR³R⁴)_{q1}-M(-NR³R⁴-)_{q2}M-(NR³R⁴)_{q3} formula (IIb)

wherein M, R³ and R⁴ have the same meanings as those in formula (II); q represents an integer of from 2 to 4; and q1 to q3 each independently represent 2 or 3.

[7] The non-aqueous liquid electrolyte for a secondary battery as described in the item [3], wherein the compound represented by formula (Icp) is a compound represented by the following formula (Ia):

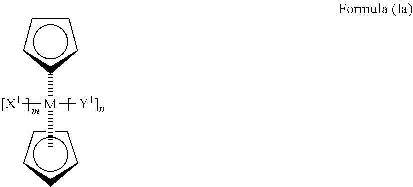

wherein X¹ and Y¹ each independently represent an alkoxy group, a thioalkoxy group, or an alkylamino group; and M, m and n have the same meanings as those in formula (I).

[8] The non-aqueous liquid electrolyte for a secondary battery as described in the item [7], wherein, in formula (Ia), m is 0, and n is 0 or 2.
[9] The non-aqueous liquid electrolyte for a secondary battery as described in any one of the items [1] to [8], wherein the organic typical metal compound is contained in an amount of 0.5 mol/L or less and 0.0001 mol/L or more.
[10] The non-aqueous liquid electrolyte for a secondary battery as described in any one of the items [1] to [9], wherein a central metal in the organic typical metal compound is Al, Si, Sn, or Mg.
[11] The non-aqueous liquid electrolyte for a secondary battery as described in any one of the items [1] to [10], further comprising a polymerizable compound.
[12] A non-aqueous secondary battery, comprising:

a positive electrode;

a negative electrode; and

the non-aqueous liquid electrolyte for a secondary battery described in any one of the items [1] to [11].

[13] The non-aqueous secondary battery as described in the item [12], wherein an active material of the positive electrode is a transition metal oxide.

### Effects of the Invention

According to the present invention, a combination of selection of additives to be contained in the liquid electrolyte and a tiny amount of blend thereof can allow improvement in cycling characteristics of the non-aqueous secondary battery.

Further, according to the present invention, a desirable result for the non-aqueous secondary battery can be obtained by using an organic typical metal compound which is soluble in an organic solvent, and by dissolving it in a liquid electrolyte. Therefore, this method can provide the situation not to necessitate cumbersome working processes such as formation of a positive electrode film made of a metal oxide or the like that is insoluble in the liquid electrolyte, and consequently can allow effective production of the secondary battery. Further, this method may take a small addition amount of the high-priced organometallic complex compound, so that a combination of improvement in cycling characteristics and a cost saving can be realized.

Other and further features and advantages of the invention will appear more fully from the following description, appropriately referring to the accompanying drawings.

### BRIEF DESCRIPTION OF THE DRAWINGS

FIG. 1 is a cross-sectional diagram schematically illustrating a mechanism of a lithium ion secondary battery according to a preferable embodiment of the present invention.

FIG. 2 is a cross-sectional diagram illustrating a specific configuration of a lithium ion secondary battery according to a preferable embodiment of the present invention.

### MODE FOR CARRYING OUT THE INVENTION

The liquid electrolyte used in the non-aqueous secondary battery of the present invention contains a particular organic typical metal compound in an organic solvent. Hereinafter, preferable embodiments thereof are explained.

### [Particular Organic Typical Metal Compound]

The particular organic typical metal compound applied in the present invention is capable of electrochemically oxidizing or reducing. Especially, the above-described organic typical metal compound is preferably a compound represented by the following formula (I).

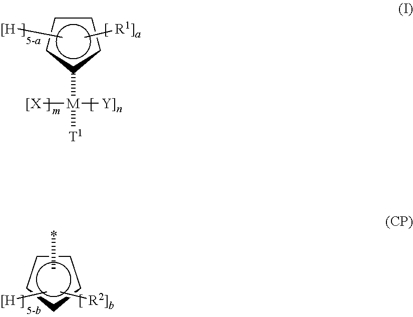

### M

In formula (I), M represents a typical metal element. Specifically, M is preferably Al, Si, Sn, or Mg.

### R¹

R¹ represents an alkyl group, an alkenyl group, an alkynyl group, an alkoxy group, a thioalkoxy group, an amino group, an alkylamino group, an amide group, an acyloxy group, a cyano group, a carboxyl group, a group containing a carbonyl group (Ra—CO—), a group containing a sulfonyl group (Ra—SO₂—), a phosphinyl group, or a halogen atom. When plural R¹'s are present, R¹'s may form an aliphatic ring or an aromatic ring. Preferable examples of the above-described R¹ are within the range of the foregoing exemplified substituents and include examples of the substituent T described below. Among these, a methyl group, a n-butyl group, a trimethylsilyl group, a dialkylamino group (preferably having 1 to 4 carbon atoms), an alkoxy group (preferably having 1 to 4 carbon atoms), and a vinyl group are preferable. In addition, the above-described Ra represents a hydrogen atom or a substituent. Preferred examples of the substituent include those exemplified as the substituent T described below. With respect to Ra, the same shall apply hereafter.

a,b

a and b each represent an integer of from 0 to 5, preferably an integer of from 0 to 4.

### X and Y

X and Y each independently represent a hydrogen atom, an alkyl group, an alkoxy group, a thioalkoxy group, an alkylamino group, a sulfonate group (Rb—SO₃—), a halogen atom, an aryl group, or a heteroaryl group. Preferable examples of the above-described X and Y are within the range of the foregoing exemplified substituents and include examples of the substituent T described below. Among these, an alkoxy group (preferably having 1 to 4 carbon atoms), a thioalkoxy group (preferably having 1 to 4 carbon atoms), and an alkylamino group (preferably having 1 to 4 carbon atoms) are preferable; an alkylamino group (preferably having 1 to 2 carbon atoms) is more preferable. The above-described Rb represents a hydrogen atom or a substituent. Preferred examples of the substituent include those exemplified as the substituent T described below. Of these, Rb is more preferably a fluoroalkyl group (preferably having 1 to 4 carbon atoms). X and Y may be linked to each other.

m, n

m and n are integers satisfying 0≦m+n≦3. The m plus n are preferably 1 or more.

### T¹

T¹ is a hydrogen atom, a methyl group, a n-butyl group, an alkylamino group, or a group represented by formula (Cp). R² in formula (Cp) has the same meaning as R¹. * means an atomic bonding. b represents an integer of from 0 to 5. R¹ and R² may be linked to each other.

The compound represented by the above-described formula (I) is preferably a compound represented by the following formula (Icp).

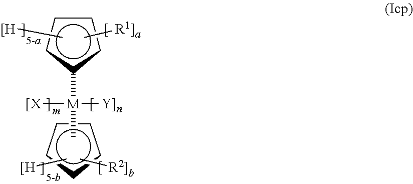

In formula (Icp), M, R¹, R², a, b, X, Y, m and n have the same meanings as those in the above-described formula (I).

The above-described compound represented by formula (I) is preferably a compound represented by the following formula (Ia).

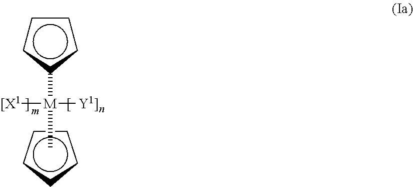

In formula (Ia), X¹ and Y¹ each independently are preferably an alkoxy group (preferably having 1 to 4 carbon atoms), a thioalkoxy group (preferably having 1 to 4 carbon atoms), or an alkylamino group (preferably having 1 to 4 carbon atoms). M, m and n have the same meanings as those in formula (I). m is preferably 0. n is preferably 0 or 2. X¹ and X² may be linked to each other.

The above-described organic typical metal compound preferably has a partial structure represented by the following formula (II).

M-NR³R⁴ formula (II)

In formula (II), M represents a typical metal element. Preferred examples of M are the same as those in the above-described formula (I).

R³ and R⁴ each independently represent a hydrogen atom, an alkyl group, an alkenyl group, an alkynyl group, an aryl group, a heteroaryl group, an alkylsilyl group, or a halogen atom. R³ and R⁴ may be linked to each other. Each of R³ and R⁴ may form a ring respectively, or R³ and R⁴ may be linked with each other to form a ring. Preferred examples of R³ and R⁴ include those exemplified as the substituent T described below. Among these, a methyl group, an isopropyl group, a t-butyl group, and a trimethylsilyl group are preferable.

R³ and R⁴ may form an aliphatic ring or an aromatic ring. Alternatively, R³ and R⁴ may be linked to each other. The ring to be formed here is preferably a pyrazole ring, a pyrrole ring, an imidazole ring, a triazole ring, a tetrazole ring, an indole ring, an isoindole ring, an indazole ring, a thiazole ring, an oxazole ring, a thiadiazole ring, an oxadiazole ring, or the like. When these rings each have a nitrogen atom, the nitrogen atom is preferably bonded with the B (boron) atom (B—N coordination).

The compound represented by the above-described formula (II) is preferably a compound represented by the following formula (IIa) or (IIb).

M-(NR³R⁴)_{q} formula (IIa)

(NR³R⁴)_{q1}-M(-NR³R⁴-)_{q2}M-(NR³R⁴)_{q3} formula (IIb)

M, R³ and R⁴ have the same meanings as those in formula (II). q represents an integer of from 2 to 4, preferably 4. q1 to q3 each independently represent 2 or 3.

Here, explanation is given about a presumptive mechanism of action which the above-described particular organic typical metal compound exerts improvement in cycling characteristics in the non-aqueous secondary battery according to a preferable embodiment of the present invention. However, the present invention is not construed in a limited way by this explanation.

In the conventional art (the above-described Patent Literature 5), ferrocene is subjected to oxidation and reduction in a liquid electrolyte, and changes reversibly to an oxide thereof. Through this oxidation and reduction reaction, the oxide acts as a carrier of lithium ion (Li⁺) at the time of overcharge of the battery, so that generation of failure due to the overcharge is suppressed. In contrast, in a preferable embodiment of the present invention, it is presumed that not a reversible reaction due to oxidation and reduction of the organic typical metal compound, but both chemical adsorption and a decomposition reaction on the positive electrode surface are involved therein. That is, it is thought that the organic typical metal compound adsorbs on the negatively (δ⁻) charged site at the time of ordinary discharge-charge, in the surface of an LMO (lithium manganese spinel oxide) or the like which constitutes a positive electrode active material. It is presumed that some sort of reaction proceeds due to the oxidation there, and a protective film (SEI) which is composed of the organic typical metal compound as a substrate is formed on the positive electrode surface whereby improvement in cycling characteristics has been realized. Meanwhile, in consideration of the foregoing reaction mechanism, it is thought that a very small amount of the organic typical metal compound is actually preferable, and therefore, instead of making the organic typical metal compound act as a redox shuttle, the organic typical metal compound acts as a material which is able to form a good protective film on the positive electrode surface, while effectively maintaining a discharge-charge cycle of the battery.

In the present invention, the above-described particular organic typical metal compound is contained in the non-aqueous liquid electrolyte in an amount of 1 mol/L or less, preferably 0.5 mol/L or less, and further preferably 0.1 mol/L or less. Advantages that a good positive electrode protective film is formed by daring to set the content of the organometallic compound to such a very small amount in this way without preventing discharge-charge of the battery is as described above. The lower limit is not particularly limited, but 0.0001 mol/L or more is practical.

Hereinafter, preferred examples of the particular organic typical metal compound will be described, but the present invention is not limited to these.

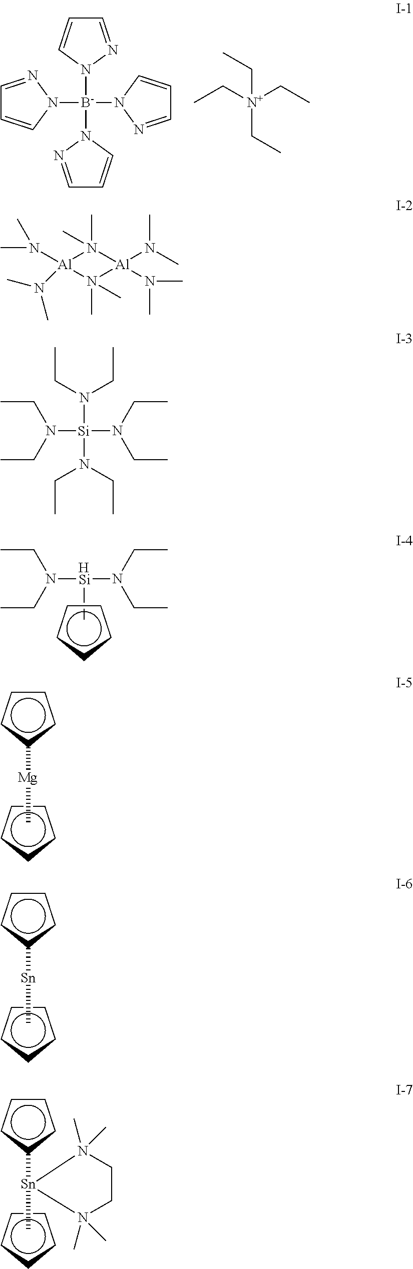

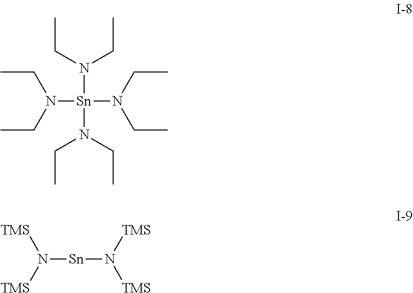 [SMILES: CC[N](CC)[Sn]([N](CC)CC)([N](CC)CC)[N](CC)CC ; C[Si](C)(C)[N]([Sn][N]([Si](C)(C)C)[Si](C)(C)C)[Si](C)(C)C]

The liquid electrolyte of the present invention preferably contains a polymerizable compound (monomer) as an additive.

Examples of the polymerizable monomer include a compound having a radical polymerizable group, a polymerizable site such that a reaction is accelerated by a Lewis acid, or both of them. It is desirable that the polymerizable compound suitable for the present invention has a basic structure which is not subject to oxidative decomposition in the positive electrode. Specifically, preferably a polymerizable monomer with an oxidation potential of 3.5 V to 5.5 V (in conversion against lithium) on the positive electrode. Further, the oxidation potential is more preferably 3.8 V to 5.0 V, furthermore preferably 4.0 V or more. The polymerizable compound is not particularly limited as long as it preferably satisfies the above-mentioned electric potential.

With respect to a specific measuring method of the oxidation potential, whether the polymerizable compound may be oxidized or not can typically be evaluated by whether a current peak of 0.1 mA/cm² or more in absolute value is shown or not, in voltammogram when the electric potential of the above-mentioned range is swept. This peak may be a broad one or the one having a shoulder, and may be evaluated and determined in the scope of producing the effect of the present invention. Alternatively, the peak may be evaluated while subtracting a base line of a chart.

Preferable examples of the radical polymerizable group which the polymerizable compound of the present invention has include (meth)acrylate, (meth)acrylic acid amide, (meth)acrylic acid imide, unsaturated carbonate, unsaturated lactone or aromatic vinyl group (styryl group).

The radical polymerizable compound and an anionic polymerizable compound preferably include a compound having a carbon-carbon multiple bond. Examples of the compound having a carbon-carbon multiple bond include a vinyl compound, a styrene derivative, a (meth)acrylate derivative, and a cyclic olefin (optionally containing a hetero atom in the ring). A compound having a carbon-carbon multiple bond and a polar functional group is more preferable. Examples of the polar functional group include an ester group, a carbonate group, a nitrile group, an amide group, a urea group, a sulfolane group, a sulfoxide group, a sulfone group, a sulfonate, a cyclic ether group and a polyalkylene oxide group. These polar groups may be chain structures or form a ring structure.

Examples of the cationic polymerizable compound include an epoxy compound, an oxetane compound; and a vinyl ether compound.

As the radical polymerizable compound, among them, a compound with a structure represented by any one of the following formulae (3-a) to (3-d) is particularly preferably used.

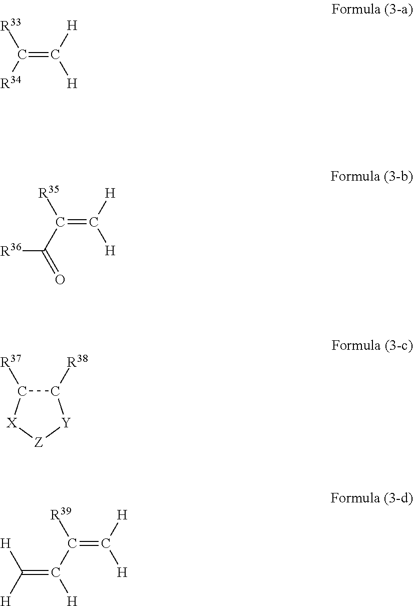

### R³³

R³³ represents a hydrogen atom or an alkyl group. The alkyl group preferable as R³³ is an alkyl group having 1 to 10 carbon atoms (such as methyl, ethyl, hexyl and cyclohexyl), and R³³ is more preferably a hydrogen atom.

### R³⁴

R³⁴ represents an aromatic group, a heterocyclic group, a nitrile group, an alkoxy group or an acyloxy group. The aromatic group of R³⁴ is preferably a 2π aromatic group having 6 to 10 carbon atoms (such as phenyl and naphtyl), the heterocyclic group is preferably a heteroaromatic group having 4 to 9 carbon atoms (such as furyl, pyridyl, pyrazyl, pyrimidyl and quinolyl), the alkoxy group is preferably an alkoxy group having 1 to 10 carbon atoms (such as methoxy, ethoxy and butoxy), the acyloxy group is preferably an acyloxy group having 1 to 10 carbon atoms (such as an acetyl group and a hexanoyloxy group), and R³⁴ is more preferably a phenyl group.

### R³⁵

R³⁵ represents a hydrogen atom, an alkyl group or a cyano group; the alkyl group is preferably an alkyl group having 1 to 10 carbon atoms (such as methyl, ethyl, hexyl and cyclohexyl), more preferably a hydrogen atom or a methyl group.

### R³⁶

R³⁶ represents an alkyl group, an alkoxy group or an amino group, more preferably an alkoxy group, that is, the compound represented by formula (3-b) is acrylate or methacrylate. The alkoxy group corresponding to an alcohol portion of the ester in this case is preferably an alkoxy group having 1 to 10 carbon atoms (such as methoxy, ethoxy and butoxy), more preferably a methoxy group or an ethoxy group.

### R³⁷ and R³⁸

R³⁷ and R³⁸ of formula (3-c) each represent a hydrogen atom, an alkyl group, an alkenyl group, or an aromatic group. However, when the expression “• • •” in the formula represents a single bond, either one of R³⁷ and R³⁸ represents an alkenyl group. In this case, the remaining R³⁷ or R³⁸ is preferably a hydrogen atom. When the expression “• • •” in the formula represents a double bond, it is preferable that each of R³⁷ and R³⁸ represents a hydrogen atom, or alternatively R³⁷ is a hydrogen atom and R³⁸ is an aromatic group. In this case, preferred examples of the aromatic group include aromatic groups having 6 to 10 carbon atoms (e.g. phenyl, naphthyl).

### X, Y and Z

X, Y and Z each represent a divalent linking group selected from —O—, —S—, —(C═O)—, —C(═S)—, —NR—, —SO—, and —SO₂— which may form a 5- or 6-membered ring; preferably, X and Y are —O— and Z is —(C═O)—. The above-mentioned R represents an alkyl group or an aromatic group. A preferable alkyl group signifies the same as that of R³³ and a preferable aromatic group signifies the same as that of R³⁴.

### R³⁹

R³⁹ represents a hydrogen atom or an alkyl group, preferably a hydrogen atom or an alkyl group having 1 to 10 carbon atoms (e.g., methyl, ethyl, hexyl, or cyclohexyl), and more preferably a hydrogen atom or a methyl group.

The substituent of R³³ to R³⁹ may further contain other substituent T.

Examples of the substituent T include an alkyl group (preferably an alkyl group having 1 to 20 carbon atoms, e.g. methyl, ethyl, isopropyl, t-butyl, pentyl, heptyl, 1-ethylpentyl, benzyl, 2-ethoxyethyl, or 1-carboxymethyl), an alkenyl group (preferably an alkenyl group having 2 to 20 carbon atoms, e.g. vinyl, allyl, or oleyl), an alkynyl group (preferably an alkynyl group having 2 to 20 carbon atoms, e.g. ethynyl, butadiynyl, or phenylethynyl), a cycloalkyl group (preferably a cycloalkyl group having 3 to 20 carbon atoms, e.g. cyclopropyl, cyclopentyl, cyclohexyl, or 4-methylcyclohexyl), an aryl group (preferably an aryl group having 6 to 26 carbon atoms, e.g. phenyl, 1-naphthyl, 4-methoxyphenyl, 2-chlorophenyl, or 3-methylphenyl), a heterocyclic group (preferably a heterocyclic group having 2 to 20 carbon atoms, more preferably a 5- or 6-membered heterocyclic group having at least one oxygen atom, sulfur atom or nitrogen atom, e.g. 2-pyridyl, 4-pyridyl, 2-imidazolyl, 2-benzimidazolyl, 2-thiazolyl, or 2-oxazolyl), an alkoxy group (preferably an alkoxy group having 1 to 20 carbon atoms, e.g. methoxy, ethoxy, isopropyloxy, or benzyloxy), an aryloxy group (preferably an aryloxy group having 6 to 26 carbon atoms, e.g. phenoxy, 1-naphthyloxy, 3-methylphenoxy, or 4-methoxyphenoxy), an alkoxycarbonyl group (preferably an alkoxycarbonyl group having 2 to 20 carbon atoms, e.g. ethoxycarbonyl, or 2-ethylhexyloxycarbonyl), an amino group (preferably an amino group, an alkylamino group and an arylamino group each having 0 to 20 carbon atoms, e.g. amino, N,N-dimethylamino, N,N-diethylamino, N-ethylamino, or anilino), a sulfamoyl group (preferably a sulfonamide group having 0 to 20 carbon atoms, e.g. N,N-dimethylsulfamoyl, or N-phenylsulfamoyl), an acyl group (preferably an acyl group having 1 to 20 carbon atoms, e.g. acetyl, propionyl, butyryl, or benzoyl), an acyloxy group (preferably an acyloxy group having 1 to 20 carbon atoms, e.g. acetyloxy, or benzoyloxy), a carbamoyl group (preferably a carbamoyl group having 1 to 20 carbon atoms, e.g. N,N-dimethylcarbamoyl, or N-phenylcarbamoyl), an acylamino group (preferably an acylamino group having 1 to 20 carbon atoms, e.g. acetylamino, or benzoylamino), a sulfonamide group (preferably a sulfamoyl group having 0 to 20 carbon atoms, e.g. methane sulfonamide, benzene sulfonamide, N-methyl methane sulfonamide, or N-ethyl benzene sulfonamide), an alkylthio group (preferably an alkylthio group having 1 to 20 carbon atoms, e.g. methylthio, ethylthio, isopropylthio, or benzylthio), an arylthio group (preferably an arylthio group having 6 to 26 carbon atoms, e.g. phenylthio, 1-naphthylthio, 3-methylphenylthio, or 4-methoxyphenylthio), an alkyl- or aryl-sulfonyl group (preferably an alkyl- or aryl-sulfonyl group having 1 to 20 carbon atoms, e.g. methylsulfonyl, ethylsulfonyl, or benzene sulfonyl), a hydroxyl group, a cyano group, and a halogen atom (e.g. a fluorine atom, a chlorine atom, a bromine atom, or an iodine atom). Among these, an alkyl group, an alkenyl group, an aryl group, a heterocyclic group, an alkoxy group, an aryloxy group, an alkoxycarbonyl group, an amino group, an acylamino group, a hydroxyl group and a halogen atom are more preferable; and an alkyl group, an alkenyl group, a heterocyclic group, an alkoxy group, an alkoxycarbonyl group, an amino group, an acylamino group and a hydroxyl group are particularly preferable.

Moreover, each group exemplified as the substituent T may be further substituted with the above-described substituent T.

When the compound, the substituent or the like contains an alkyl group, an alkenyl group or the like, these groups may be linear or branched, and may be substituted or unsubstituted. Furthermore, when the compound, substituent or the like contains an aryl group, a heterocyclic group or the like, they may be monocyclic or fused-cyclic, and may be substituted or unsubstituted.

It is noted that the representation of the compound or the complex, in the present specification, is used in the sense that not only the compound or the complex itself, but also its salt or its ion are incorporated therein. For example, when the expression “contain a transition metal metallocene” is mentioned, such expression means that the transition metal metallocene may exist in a liquid electrolyte in the form of a metallocenium ion or its salt. Further, it is used in the sense that the compound includes a derivative thereof which is modified in a predetermined part in the range of achieving a desired effect. Further, in the present specification, a substituent or a linking group that is not specified by substitution or non-substitution means that the substituent may have an optional substituent. This is applied to the compound that is not specified by substitution or non-substitution. Preferable examples of the substituent include the substituent T described below.

Examples of the polymerizable compound are described below. However, the present invention is not construed by being limited thereto.

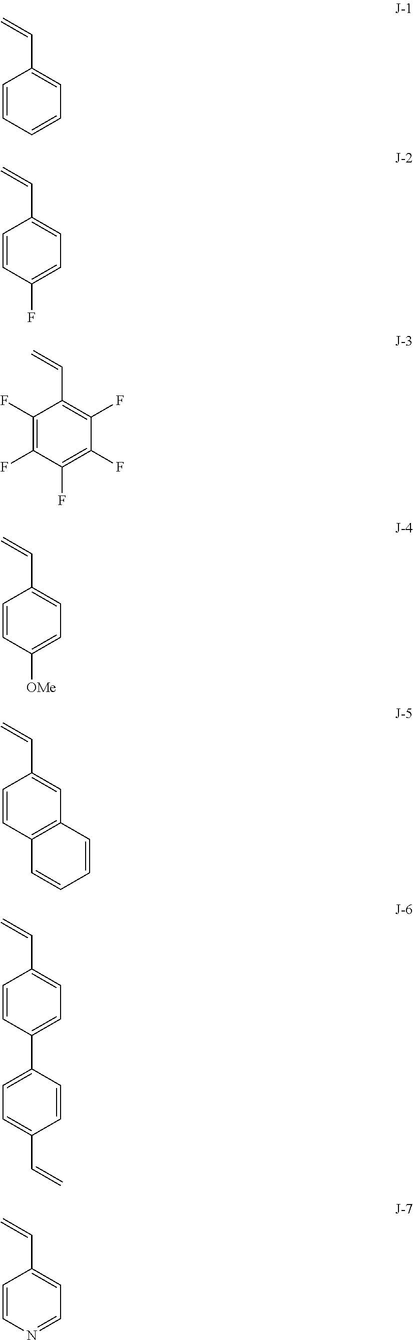

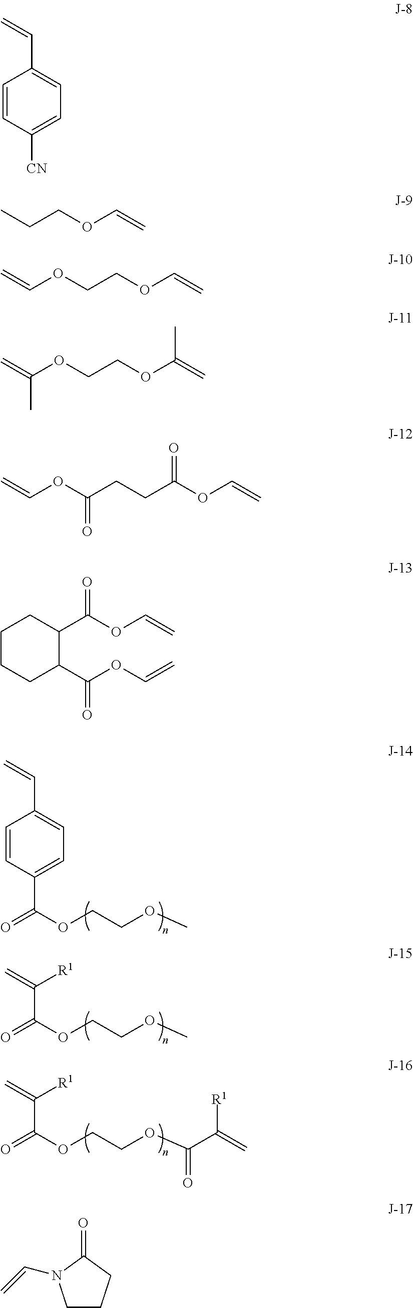

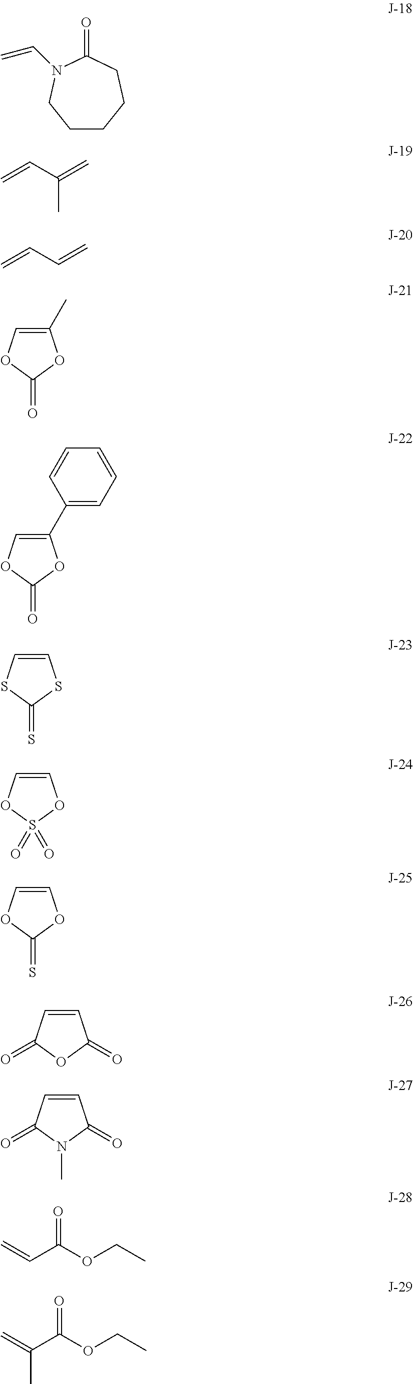

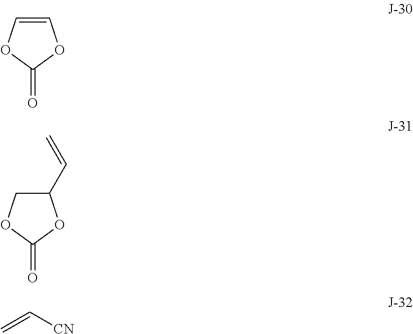

R¹ represents a hydrogen atom, an alkyl group, a halogen atom, or a cyano group.

n represents an integer of 1 to 20.

Examples of the polymerizable site contained in the polymerizable compound such that a reaction is accelerated by a Lewis acid include a cycloalkane group, an epoxy group, an oxetane group, a vinyl group, an isocyanate group, an alkoxysilane group, a hydrosilane group, and a transition metal alkoxide structure. The transition metals of Group IV of the Periodic Table such as titanium, zirconium and hafnium are selected as the central metal of the transition metal alkoxide.

The functional group is more preferably a cycloalkane group, a vinyl group, an isocyanate group, an alkoxysilane group, and a transition metal alkoxide structure, furthermore preferably a cycloalkane group, a vinyl group, an alkoxysilane group, and a transition metal alkoxide structure. Titanium and zirconium are preferable as a central metal of the transition metal.

The compound having both a radical polymerizable site and a polymerizable site such that a reaction is accelerated by a Lewis acid is more preferably a compound having any structure of the following formulae (V) to (VII).

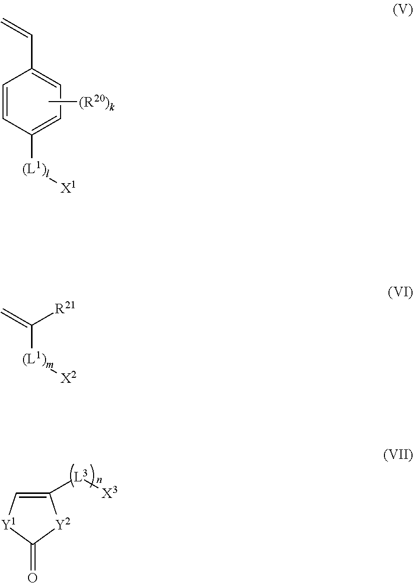

In formulae (V) to (VII), R²⁰ and R²¹ represent an alkyl group, a fluoroalkyl group, an alkoxy group, a thioalkoxy group (alkylsulfanyl group), a cyano group, a halogen and a group containing a carbonyl group (e.g., an acyl group). k, m, n and 1 represent an integer of 1 to 5. Each of L¹ to L³ is a linking group. The linking group is preferably an alkylene group, an alkylene oxide group, an alkyleneoxycarbonyl group, an ether group, a thioether group (a sulfide group) and an amide group.

Y¹ and Y² represent any one of —O—, —CH₂— and —NH—. Besides, each of X¹ to X³ is a polymerizable site such that a reaction is accelerated by a Lewis acid. Examples thereof include a cycloalkyl group, an epoxy group, an oxetane group, a vinyl group, an isocyanate group, an alkoxysilyl group, a hydrosilyl group, or a transition metal alkoxide structure.

With regard to the added amount of the polymerizable monomer, in the case where the amount is too small, the effect of improving cycle characteristics is small; in the case where the amount is too large, internal resistance of a battery increases, so that initial characteristics of the battery is deteriorated. The concentration range thereof is preferably a range of 5.0×10⁻¹ mol/L to 1.0×10⁻² mol/L with respect to each liquid electrolyte.

### (Organic Solvent)

Examples of the organic solvent used in the present invention include ethylene carbonate, propylene carbonate, butylene carbonate, dimethyl carbonate, diethyl carbonate, ethyl methyl carbonate, methyl propyl carbonate, γ-butyrolactone, γ-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, methyl trimethylacetate, ethyl trimethylacetate, acetonitrile, glutaronitrile, adiponitrile, methoxyacetonitrile, 3-methoxypropionitrile, N,N-dimethylformamide, N-methylpyrrolidinone, N-methyl oxazolidinone, N,N′-dimethylimidazolidinone, nitromethane, nitroethane, sulfolane, trimethyl phosphate, dimethyl sulfoxide, dimethyl sulfoxide, and phosphoric acid. These may be used alone or in combination of two or more. Of these, at least one selected from the group consisting of ethylene carbonate, propylene carbonate, dimethyl carbonate, diethyl carbonate and ethyl methyl carbonate is preferred. In particular, a combination of a high-viscosity (high-dielectric constant) solvent (for example, having a relative permittivity ∈ of 30 or more) such as ethylene carbonate or propylene carbonate with a low-viscosity solvent (for example, having a viscosity of up to 1 mPa·s) such as dimethyl carbonate, ethyl methyl carbonate or diethyl carbonate is more preferred because the dissociation ability and the ionic mobility of the electrolytic salt are improved.

In addition, the solvent may contain a cyclic carbonate ester having an unsaturated bond because the chemical stability of the liquid electrolyte is further improved. For example, at least one selected from the group consisting of a vinylene carbonate based compound, a vinyl ethylene carbonate based compound, and a methylene ethylene carbonate based compound is used as the cyclic carbonate ester having an unsaturated bond.

Examples of the vinylene carbonate based compound include vinylene carbonate (1,3-dioxol-2-one), methyl vinylene carbonate (4-methyl-1,3-dioxol-2-one), ethyl vinylene carbonate (4-ethyl-1,3-dioxol-2-one), 4,5-dimethyl-1,3-dioxol-2-one, 4,5-diethyl-1,3-dioxol-2-one, 4-fluoro-1,3-dioxol-2-one, and 4-trifluoromethyl-1,3-dioxol-2-one.

Examples of the vinyl ethylene carbonate based compound include vinyl ethylene carbonate (4-vinyl-1,3-dioxolan-2-one), 4-methyl-4-vinyl-1,3-dioxolan-2-one, 4-ethyl-4-vinyl-1,3-dioxolan-2-one, 4-n-propyl-4-vinyl-1,3-dioxolan-2-one, 5-methyl-4-vinyl-1,3-dioxolan-2-one, 4,4-divinyl-1,3-dioxolan-2-one, and 4,5-divinyl-1,3-dioxolan-2-one.

Examples of the methylene ethylene carbonate based compound include 4-methylene-1,3-dioxolan-2-one, 4,4-dimethyl-5-methylene-1,3-dioxolan-2-one and 4,4-diethyl-5-methylene-1,3-dioxolan-2-one.

These may be used alone or as a mixture of two or more thereof. Of these, vinylene carbonate is preferable.

### (Electrolyte)

Electrolyte that can be used in the liquid electrolyte of the present invention includes a metal ion or a salt thereof, and a metal ion belonging to Group I or Group II of the Periodic Table or a salt thereof are preferable. The electrolyte is suitably selected depending on the purpose of a liquid electrolyte. For example, lithium salts, potassium salts, sodium salts, calcium salts, and magnesium salts can be mentioned. In the case where the liquid electrolyte is used in a secondary battery or the like, a lithium salt is preferred from the viewpoint of the output power of the secondary battery. In the case of using the liquid electrolyte of the present invention as the electrolyte of a non-aqueous liquid electrolyte for lithium secondary batteries, it is desirable to select a lithium salt as the salt of the metal ion. The lithium salt is not particularly limited as long as it is a lithium salt that is usually used in the electrolyte of a non-aqueous liquid electrolyte for lithium secondary batteries, but for example, the salts described below are preferred.

(L-1) Inorganic lithium salt: inorganic fluoride salt such as LiPF₆, LiBF₄, LiAsF₆, LiSbF₆; perhalogenic acid salts such as LiClO₄, LiBrO₄, LiIO₄; and inorganic chloride salt such as LiAlCl₄, and the like.
(L-2) Organic lithium salt containing fluorine: perfluoroalkanesulfonic acid salt such as LiCF₃SO₃; perfluoroalkanesulfonylimide salts such as LiN(CF₃SO₂)₂, LiN(CF₃CF₂SO₂)₂, LiN(FSO₂)₂, and LiN(CF₃SO₂)(C₄F₉SO₂); perfluoroalkanesulfonylmethide salts such as LiC(CF₃SO₂)₃; fluoroalkyl fluorophosphoric acid salts such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃)₂], and Li[PF₃(CF₂CF₂CF₂CF₃)₃], and the like.
(L-3) Oxalatoborate salts: lithium bis(oxalato)borate, lithium difluoro(oxalato)borate, and the like.

Among these, LiPF₆, LiBF₄, LiAsF₆, LiSbF₆, LiClO₄, Li(Rf¹SO₃), LiN(Rf¹SO₂)₂, LiN(FSO₂)₂, and LiN(Rf¹SO₂)(Rf²SO₂)₂, are preferred; and lithium imide salts such as LiPF₆, LiBF₄, LiN(Rf¹SO₂)₂, LiN(FSO₂)₂ and LiN(Rf¹SO₂)(Rf²SO₂)₂ are more preferred. Herein, Rf¹ and Rf² each represent a perfluoroalkyl group.

Meanwhile, as for the lithium salt that is used in the liquid electrolyte, one kind may be used alone, or any two or more kinds may be used in combination.

The ion of metal belonging to Group I or Group II of the Periodic Table of Elements or the salt thereof is added to the liquid electrolyte in such an amount that the electrolyte is contained at a preferred salt concentration to be mentioned in the method for preparing the liquid electrolyte below. The salt concentration is appropriately selected according to the purpose of the liquid electrolyte, but the content is usually 10 mass % or more and 50 mass % or less, and more preferably 15 mass % or more and 30 mass % or less, relative to the total mass of the liquid electrolyte. When evaluated as the ionic concentration, the salt concentration need only be calculated in terms of the salt with an advantageously applied metal.

### (Other Components)

The liquid electrolyte of the present invention may contain at least one selected from the group consisting of a negative electrode film-forming agent, a flame retardant and an overcharge preventing agent. The content ratio of these functional additives in the non-aqueous liquid electrolyte is not particularly limited but is each preferably 0.001% by mass to 10% by mass with respect to the whole non-aqueous liquid electrolyte. The addition of these compounds allows rupture and ignition of a battery to be restrained under an abnormal condition due to overcharge, and allows capacity maintenance characteristics and cycling characteristics after preserving at high temperature to be improved.

### [Method of Preparing Liquid Electrolyte and the Like]

The non-aqueous liquid electrolyte for a secondary battery of the present invention is prepared by a usual method in such a manner that the above-mentioned each component is dissolved in the non-aqueous liquid electrolyte solvent, including an example using a lithium salt as a salt of metal ion.

The term “non-aqueous” as used in the present invention means that water is substantially not contained and a small amount of water may be contained as long as the effects of the present invention are not impaired. In consideration of obtaining good properties, water is preferably contained in an amount of up to 200 ppm (mass standard) and more preferably up to 100 ppm. Although the lower limit is not particularly restricted, it is practical for the water content to be 10 ppm or more in consideration of inevitable incorporation. Although the viscosity of the liquid electrolyte of the present invention is not particularly limited, the viscosity at 25° C. is preferably 10 to 0.1 mPa·s, more preferably 5 to 0.5 mPa·s.

### (Kit)

The liquid electrolyte of the present invention may be formed from a kit composed of plural liquids, powders or the like. For example, the liquid electrolyte may be in a form that a first agent (first liquid) is composed of an electrolyte and an organic solvent, a second agent (second liquid) is composed of the particular organic typical metal compound and an organic solvent, and the two liquids are mixed to prepare a liquid before use. At this time, in the kit of the present invention, the other additives and the like are contained in the first agent, the second agent and/or another agent (third agent). This will allow an interaction between the above-mentioned polymerizable monomer and the above-mentioned polymerization initiator to be effectively obtained. In addition, the contents of the various components described above are preferably such that the contents are in the ranges described above after the components are mixed.

### [Secondary Battery]

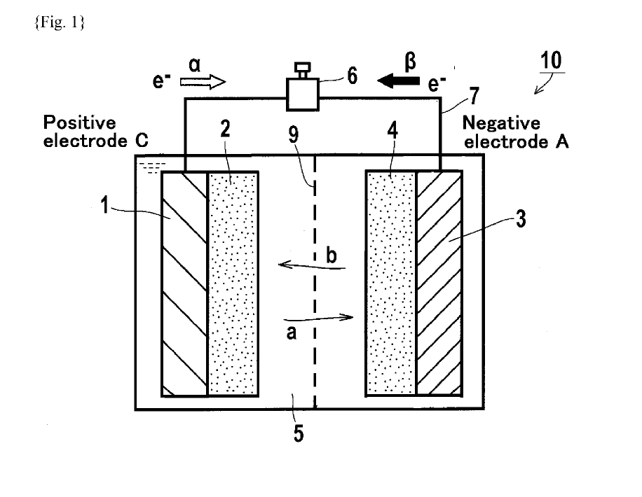

In the present invention, a non-aqueous secondary battery preferably contains the above-mentioned non-aqueous liquid electrolyte. A preferable embodiment is described while referring to FIG. 1 schematically illustrating a mechanism of a lithium ion secondary battery. Here, the scope of the present invention is not limited by the drawing and the description thereof.

Lithium ion secondary battery 10 of the present embodiment includes non-aqueous liquid electrolyte 5 for a secondary battery, positive electrode C (current collector for positive electrode 1, positive-electrode active material layer 2) capable of inserting (intercalating) and releasing (deintercalating or discharging) of lithium ions, and negative electrode A (current collector for negative electrode 3, negative electrode active material layer 4) capable of inserting and releasing, or dissolving and precipitating, of lithium ions. In addition to these essential members, the lithium secondary battery may also be constructed to include separator 9 that is disposed between the positive electrode and the negative electrode, current collector terminals (not shown), and an external case (not shown), in consideration of the purpose of using the battery, the form of the electric potential, and the like. According to the necessity, a protective element may also be mounted in at least any one side of the interior of the battery and the exterior of the battery. By employing such a structure, transfer of lithium ions a and b occurs in liquid electrolyte 5, and charging a and discharging 13 can be carried out. Thus, operation and charging can be carried out by means of operating means 6 through circuit wiring 7.

### (Battery Shape)

There are no particular limitations on the battery shape that is applied to the lithium secondary battery of the present embodiment, and examples of the shape include a bottomed cylindrical shape, a bottomed rectangular shape, a thin flat shape, a sheet shape, and a paper shape. The lithium secondary battery of the present embodiment may have any of these shapes. Furthermore, an atypical shape such as a horseshoe shape or a comb shape, which is designed in consideration of the form of the system or device into which the lithium secondary battery is incorporated, may also be used. Among them, from the viewpoint of efficiently releasing the heat inside of the battery to the outside thereof, a rectangular shape such as a bottomed rectangular shape or a thin flat shape, which has at least one relatively flat and large-sized surface, is preferred.

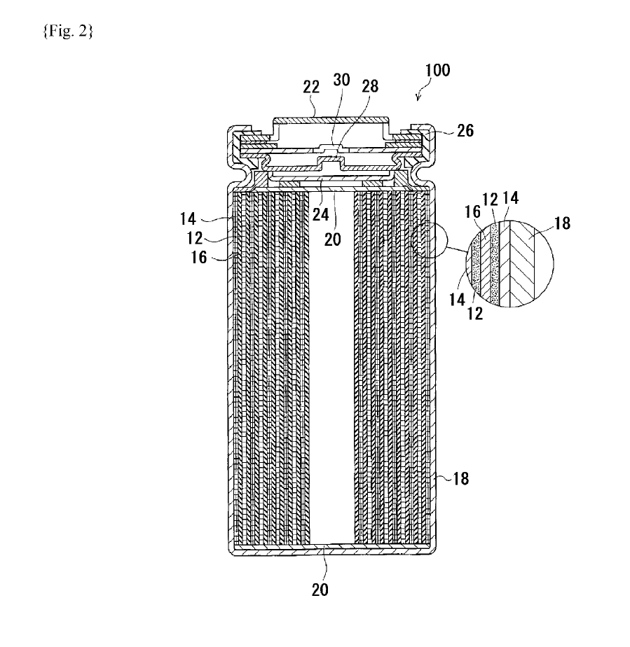

In a battery having a bottomed cylindrical shape, since the external surface area relative to the power-generating element to be charged is small, it is preferable to design the battery such that the Joule heating that is generated due to the internal resistance at the time of charging or discharging is efficiently dissipated to the outside. Furthermore, it is preferable to design the lithium secondary battery such that the filling ratio of a substance having high heat conductivity is increased so as to decrease the temperature distribution inside the battery. The battery having a bottomed cylindrical shape will be described later together with FIG. 2.

### (Battery-Constituting Members)

The lithium secondary battery of the present embodiment is constituted to include liquid electrolyte 5, positive electrode mixture C and negative electrode mixture A, and basic member of separator 9, based on the figure. Each of these members will be described below.

### (Electrode Mixtures)

In the present embodiment, an electrode mixture is a sheet-like substance formed by applying a dispersion of an active substance, an electroconductive agent, a binder, a filler and the like on a current collector (electrode substrate). For a lithium battery, a positive electrode mixture in which the active substance is a positive electrode active substance, and a negative electrode mixture in which the active substance is a negative electrode active substance are usually used. Next, each component in the dispersion composing the electrode mixture (mixture, composition for electrode) is described.

### Positive Electrode Active Substance

In the present invention, a transition metal oxide is used for the positive electrode active substance. As for this transition metal oxide, preferred is a material having a charging region which the above-described organic typical metal compound can be oxidized, or a transition metal oxide material which allows inserting and releasing of an alkali metal ion. Specifically, a lithium-containing transition metal oxide having a lithium-inserting/releasing potential peak at 3.5 V or more vs. lithium is preferable. The inserting/releasing potential peak is more preferably 3.8 V or more, and most preferably 4.0 V or more. The inserting/releasing potential peak at this time can be identified by preparing a thin-film electrode having a positive electrode active substance in accordance with a Sol-Gel method or a sputtering method and then conducting an electrochemical measurement (cyclic voltammetry).

As a positive electrode active substance, a particulate positive electrode active substance may be used. Specifically, as the positive electrode active substance, a transition metal oxide which is capable of reversible inserting and releasing of lithium ions can be used, but it is preferable to use a lithium-containing transition metal oxide. Suitable examples of a lithium-containing transition metal oxide that is preferably used as a positive electrode active substance, include lithium-containing oxides containing one or more of Ti, V, Cr, Mn, Fe, Co, Ni, Cu, Mo, and W. Furthermore, alkali metals other than lithium (elements of Group 1 (Ia) and Group 2 (IIa) of the Periodic Table), and/or Al, Ga, In, Ge, Sn, Pb, Sb, Bi, Si, P, B and the like may also be incorporated. The amount of incorporation is preferably from 0 mol % to 30 mol % relative to the amount of the transition metal.

Among the lithium-containing transition metal oxides that are preferably used as the positive electrode active substance, a substance synthesized by mixing a lithium compound and a transition metal compound (herein, the transition metal refers to at least one selected from Ti, V, Cr, Mn, Fe, Co, Ni, Mo, and W) such that the total molar ratio of lithium compound/transition metal compound is 0.3 to 2.2.

Furthermore, among the lithium compound/transition metal compound, materials containing Li_{g}M3O₂ (wherein M3 represents one or more elements selected from Co, Ni, Fe, and Mn; and g represents 0 to 1.2, preferably 0.02 to 1.2), or materials having a spinel structure represented by LiₕM4₂O (wherein M4 represents Mn; and h represents 0 to 2, preferably 0.02 to 2) are particularly preferred. As M3 and M4 described above, Al, Ga, In, Ge, Sn, Pb, Sb, Bi, Si, P, B, or the like may also be incorporated in addition to the transition metal. The amount of incorporation is preferably from 0 mol % to 30 mol % relative to the amount of the transition metal.

Among the materials containing Li_{g}M3O₂ and the materials having a spinel structure represented by LiₕM4₂O₄, Li_{g}CoO₂ (lithium cobalt oxide), Li_{g}NiO₂ (lithium nickel oxide), Li_{g}MnO₂ (lithium manganese oxide), Li_{g}CoⱼNi₁₋ⱼO₂, LiₕMn₂O₄, LiNiⱼMn₁₋ⱼO₂, LiCoⱼNiₕAl₁₋ⱼ₋ₕO₂ (lithium nickel cobalt aluminum oxide), LiCoⱼNiₕMn₁₋ⱼ₋ₕO₂ (lithium nickel manganese cobalt oxide), LiMnₕAl₂₋ₕO₄, LiMnₕNi₂₋ₕO₄ (lithium manganese nickel oxide) (wherein in the respective formulas, g represents 0 to 2, preferably 0.02 to 1.2; j represents 0.1 to 0.9; and h represents 0 to 2, preferably 0.02 to 2) are particularly preferred; and Li_{g}CoO₂, LiMn₂O₄, LiNi_{0.85}Co_{0.01}Al_{0.05}O₂, and LiNi_{0.33}Co_{0.33}Mn_{0.33}O₂ are further preferred. From the viewpoints of high capacity and high power output, among those described above, an electrode containing Ni is more preferred. Herein, the g value and the h value are values prior to the initiation of charging and discharging, and are values that increase or decrease as charging or discharging occurs. Specific examples thereof include LiCoO₂, LiNi_{0.5}Mn_{0.5}O₂, LiNi_{0.85}Co_{0.01}Al_{0.05}O₂, LiNi_{0.33}Co_{0.33}Mn_{0.33}O₂, LiMn_{1.8}Al_{0.2}O₄, and LiMn_{1.5}Ni_{0.5}O₄.

Preferred examples of the transition metal of the lithium-containing transition metal phosphate compound include V, Ti, Cr, Mn, Fe, Co, Ni, and Cu, and specific examples of the compound include iron phosphates (lithium iron phosphates) such as LiFePO₄, Li₃Fe₂(PO₄)₃, and LiFeP₂O₇; cobalt phosphates such as LiCoPO₄; and compounds in which a portion of the transition metal atoms that constitute the main component of these lithium-transition metal phosphate compounds has been substituted by another metal such as Al, Ti, V, Cr, Mn, Fe, Co, Li, Ni, Cu, Zn, Mg, Ga, Zr, Nb, or Si.

The average particle size of the positive electrode active substance used in the non-aqueous electrolyte secondary battery of the present invention is not particularly limited, but the average particle size is preferably from 0.1 μm to 50 μm. The specific surface area is not particularly limited, but the specific surface area as measured by the BET method is preferably from 0.01 m²/g to 50 m²/g. Furthermore, the pH of the supernatant obtainable when 5 g of the positive electrode active substance is dissolved in 100 mL of distilled water is preferably from 7 to 12.

In the case where a conventionally used TiS₂ is used for the positive electrode active substance, this has a lower charge/discharge potential than the transition metal oxide positive electrode. As a result, the charge/discharge potential may not reach an electrode potential enough to oxidize the above-described particular organic typical metal compound. In this case, a positive electrode protective film cannot be formed efficiently and therefore this limits the effect of protecting a positive electrode according to the present invention.

In order to adjust the positive electrode active substance to a predetermined particle size, a well-known pulverizer or classifier may be used. For example, a mortar, a ball mill, a vibrating ball mill, a vibrating mill, a satellite ball mill, a planetary ball mill, a swirling air flow jet mill, or a sieve is used. The positive electrode active substance obtained according to the above-described calcination method may be used after washing the substance with water, an acidic aqueous solution, an alkaline aqueous solution, or an organic solvent.

The amount of the positive-electrode active material to be mixed in is not particularly limited. However, provided that the amount of solid content in the dispersion (mixture) forming the electrode mixture is 100% by mass, the amount of the positive-electrode active material is preferably 60% by mass to 98% by mass, and more preferably 70% by mass to 95% by mass.

### Negative Electrode Active Substance

There are no particular limitations on the negative electrode active substance, as long as the negative electrode active substance is capable of reversible inserting and releasing of lithium ions, and examples thereof include carbonaceous materials, metal oxides such as tin oxide and silicon oxide, metal composite oxides, simple lithium substance or lithium alloys such as a lithium-aluminum alloy, and metals capable of forming an alloy with lithium, such as Sn and Si.

For these materials, one kind may be used alone, or two or more kinds may be used in any combination at any proportions. Among them, carbonaceous materials or lithium composite oxides are preferably used from the viewpoint of safety.

Furthermore, the metal composite oxides are not particularly limited as long as the materials are capable of adsorbing and releasing of lithium, but it is preferable for the composite oxides to contain titanium and/or lithium as constituent components, from the viewpoint of high current density charging-discharging characteristics.

A carbonaceous material that is used as a negative electrode active substance is a material which is substantially composed of carbon. Examples thereof include petroleum pitch, natural graphite, artificial graphite such as vapor-grown graphite, and carbonaceous materials obtained by calcinating various synthetic resins such as PAN-based resins and furfuryl alcohol resins. Further, the examples include various carbon fibers such as PAN-based carbon fibers, cellulose-based carbon fibers, pitch-based carbon fibers, vapor-grown carbon fibers, dehydrated PVA-based carbon fibers, lignin carbon fibers, vitreous carbon fibers, and activated carbon fibers; mesophase microspheres, graphite whiskers, and tabular graphite.

These carbonaceous materials may be classified into hardly graphitized carbon materials and graphite-based carbon materials, according to the degree of graphitization. Also, it is preferable that the carbonaceous materials have the plane spacing, density, and size of crystallites described in JP-A-62-22066, JP-A-2-6856, and JP-A-3-45473. The carbonaceous materials are not necessarily single materials, and a mixture of natural graphite and an artificial graphite as described in JP-A-5-90844, a graphite having a coating layer as described in JP-A-6-4516, and the like can also be used.

In regard to the metal oxides and metal composite oxides that are negative electrode active substances used in the non-aqueous secondary battery, at least one of these may be included. The metal oxides and metal composite oxides are particularly preferably amorphous oxides, and furthermore, chalcogenides which are reaction products of metal elements and the elements of Group 16 of the Periodic Table of Elements are also preferably used. The term amorphous as used herein means that the substance has a broad scattering band having an apex at a 20 value in the range of 20° to 40°, as measured by an X-ray diffraction method using CuKα radiation, and the substance may also have crystalline diffraction lines. The highest intensity obtainable among the crystalline diffraction lines exhibited at a 20 value in the range of from 40° to 70° is preferably 100 times or less, and more preferably 5 times or less, than the diffraction line intensity of the apex of the broad scattering band exhibited at a 20 value in the range of from 20° to 40°, and it is particularly preferable that the substance does not have any crystalline diffraction line.

Among the group of compounds composed of the amorphous oxides and chalcogenides, amorphous oxides and chalcogenides of semi-metallic elements are more preferred, and oxides and chalcogenides formed from one kind alone or combinations of two or more kinds of the elements of Group 13 (IIIB) to Group 15 (VB) of the Periodic Table of Elements, Al, Ga, Si, Sn, Ge, Pb, Sb and Bi are particularly preferred. Specific preferred examples of the amorphous oxides and chalcogenides include, for example, Ga₂O₃, SiO, GeO, SnO, SnO₂, PbO, PbO₂, Pb₂O₃, Pb₂O₄, Pb₃O₄, Sb₂O₃, Sb₂O₄, Sb₂O₅, Bi₂O₃, Bi₂O₄, SnSiO₃, GeS, SnS, SnS₂, PbS, PbS₂, Sb₂S₃, Sb₂S₅, and SnSiS₃. Furthermore, these may also be composite oxides with lithium oxide, for example, Li₂SnO₂.

The average particle size of the negative electrode active substance used in the non-aqueous secondary battery is preferably from 0.1 μm to 60 μm. In order to adjust the negative electrode active substance to a predetermined particle size, a well-known pulverizer or classifier may be used. For example, a mortar, a ball mill, a sand mill, a vibrating ball mill, a satellite ball mill, a planetary ball mill, a swirling air flow jet mill, and a sieve are favorably used. At the time of pulverization, wet pulverization of using water or an organic solvent such as methanol to co-exist with the negative electrode active substance can also be carried out as necessary. In order to obtain a desired particle size, it is preferable to perform classification. There are no particular limitations on the classification method, and a sieve, an air classifier or the like can be used as necessary. Classification may be carried out by using a dry method as well as a wet method.

The chemical formula of the compound obtained by the calcination method can be obtained by using an inductively coupled plasma (ICP) emission spectroscopic method as a measurement method. Alternatively, as a convenient method, the chemical formula can be calculated from the mass difference of the powder measured before and after calcination.

Suitable examples of the negative electrode active substance that can be used together with the amorphous oxide negative electrode active substances represented by Sn, Si and Ge, include carbonaceous materials that are capable of adsorbing and releasing of lithium ions or lithium metal, as well as lithium, lithium alloys, and metal capable of alloying with lithium.

In the present invention, it is preferable to use lithium titanate, more specifically lithium titanium oxide (Li[Li_{1/3}Ti_{5/3}]O₄), as an active material of the negative electrode.

The amount of the negative electrode active material mixed in the dispersion (mixture) forming the electrode mixture is not particularly limited. However, the amount is preferably 60% by mass to 98% by mass and more preferably 70% by mass to 95% by mass, based on 100% by mass of the solid content.

### Electroconductive Material

As for the electroconductive material, any material may be used as long as it is an electron conductive material which does not cause a chemical change in a constructed secondary battery, and any known electroconductive material can be used. Usually, electroconductive materials such as natural graphite (scale-like graphite, flaky graphite, earthly graphite, and the like), artificial graphite, carbon black, acetylene black, Ketjen black, carbon fibers, metal powders (copper, nickel, aluminum, silver (described in JP-A-63-148, 554), and the like), metal fibers, and polyphenylene derivatives (described in JP-A-59-20,971) can be incorporated alone or as mixtures thereof. Among them, a combination of graphite and acetylene black is particularly preferred. The amount of the conductive material to be mixed, in the dispersion (mixture) forming the electrode mixture, is preferably 0.1% by mass to 50% by mass, and more preferably 0.5% by mass to 30% by mass, based on 100% by mass of the solid content. In the case of carbon or graphite, the amount of addition is particularly preferably from 0.5 mass % to 15 mass % in the dispersion.

### Binder

Preferred examples of the binder include polysaccharides, thermoplastic resins, and polymers having rubber elasticity, and among them, preferred examples include emulsions (latexes) or suspensions of starch, carboxymethyl cellulose, cellulose, diacetyl cellulose, methyl cellulose, hydroxyethyl cellulose, hydroxypropyl cellulose, sodium alginate; water-soluble polymers such as poly(acrylic acid), poly(sodium acrylate), polyvinylphenol, poly(vinyl methyl ether), poly(vinyl alcohol), polyvinylpyrrolidone, polyacrylonitrile, polyacrylamide, poly(hydroxy(meth)acrylate), and a styrene-maleic acid copolymer; poly(vinyl chloride), polytetrafluoroethylene, poly(vinylidene fluoride), a tetrafluoroethylene-hexafluoropropylene copolymer, a vinylidene fluoride-tetrafluoroethylene-hexafluoropropylene copolymer, polyethylene, polypropylene, an ethylene-propylene-diene terpolymer (EPDM), a sulfonated EPDM, a poly(vinyl acetal) resin, (meth)acrylic acid ester copolymers containing (meth)acrylic acid esters such as methyl methacrylate and 2-ethylhexyl acrylate, a (meth)acrylic acid ester-acrylonitrile copolymer, a poly(vinyl ester) copolymer containing a vinyl ester such as vinyl acetate, a styrene-butadiene copolymer, an acrylonitrile-butadiene copolymer, polybutadiene, a neoprene rubber, a fluorine rubber, poly(ethylene oxide), a polyester polyurethane resin, a polyether polyurethane resin, a polycarbonate polyurethane resin, a polyester resin, a phenolic resin, and an epoxy resin. More preferred examples include a poly(acrylic acid ester)-based latex, carboxymethyl cellulose, polytetrafluoroethylene, and poly(vinylidene fluoride).

As for the binder, one kind may be used alone, or two or more kinds may be used as mixtures. If the amount of addition of the binder is small, the retention power and the aggregating power of the electrode mixture are weakened. If the amount of addition is too large, the electrode volume increases, and the capacity per unit volume or unit mass of the electrode is decreased. For such reasons, in the dispersion (mixture) forming the electrode mixture, the amount of addition of the binder is preferably from 1 mass % to 30 mass %, and more preferably from 2 mass % to 10 mass %, based on 100 mass % of the solid content.

### Filler

The electrode mixture may contain a filler. Regarding the material that forms the filler, any fibrous material that does not cause a chemical change in the secondary battery of the present invention can be used. Usually, fibrous fillers formed from olefinic polymers such as polypropylene and polyethylene, and materials such as glass and carbon are used. The amount of addition of the filler is not particularly limited. However, in the dispersion (mixture) forming the electrode mixture, the amount of addition is preferably from 0 mass % to 30 mass %, based on 100 mass % of the solid content.

### Current Collector

As the current collector for the positive and negative electrodes, an electron conductor that does not cause a chemical change in the non-aqueous electrolyte secondary battery of the present invention is used. Preferred examples of the current collector for the positive electrode include aluminum, stainless steel, nickel, and titanium, as well as aluminum or stainless steel treated with carbon, nickel, titanium, or silver on the surface. Among them, aluminum and aluminum alloys are more preferred.

Preferred examples of the current collector for the negative electrode include aluminum, copper, stainless steel, nickel, and titanium, and more preferred examples include aluminum, copper and copper alloys.

Regarding the shape of the current collector, a film sheet-shaped current collector is usually used, but a net-shaped material, a film sheet formed by punching, a lath material, a porous material, a foam, a material obtained by molding a group of fibers, and the like can also be used. The thickness of the current collector is not particularly limited, but the thickness is preferably from 1 μm to 500 μm. Furthermore, it is also preferable to provide surface unevenness on the surface of the current collector through a surface treatment.

Electrode mixtures for lithium secondary batteries are formed by members appropriately selected from these materials.

### (Separator)

The separator that can be used in the present invention is not particularly limited as long as the separator is formed of a material which has mechanical strength to electronically insulate the positive electrode and the negative electrode; ion permeability; and oxidation-reduction resistance at the surfaces in contact with the positive electrode and the negative electrode. As such materials, porous polymer materials or inorganic materials, organic-inorganic hybrid materials, and glass fibers may be used. These separators preferably have a shutdown function for securing safety, that is, a function of increasing resistance by blocking the voids at 80° C. or higher, and thereby cutting off the electric current, and the blocking temperature is preferably 90° C. or higher and 180° C. or lower.

The shape of the pores of the separator is usually circular or elliptical, and the size thereof is from 0.05 μm to 30 μm, and preferably from 0.1 μm to 20 μm. Furthermore, as in the case of producing the material by an extension method or a phase separation method, a material having rod-shaped or irregularly shaped pores may also be used. The proportion occupied by these pores, that is, the pore ratio, is 20% to 90%, and preferably 35% to 80%.

Regarding the polymer materials described above, a single material such as cellulose nonwoven fabric, polyethylene, or polypropylene may be used, or a compositized material of two or more kinds may also be used. A laminate of two or more kinds of finely porous films that are different in the pore size, pore ratio, pore blocking temperature and the like, is preferred.

As the inorganic material, oxides such as alumina and silicon dioxide, nitrides such as aluminum nitride and silicon nitride, and sulfates such as barium sulfate and calcium sulfate are used, and a particle-shaped or fiber-shaped material is used. Regarding the form, a thin film-shaped material such as a nonwoven fabric, a woven fabric, or a finely porous film is used. In the case of a thin film-shaped material, a material having a pore size of from 0.01 μm to 1 μm and a thickness of from 5 μm to 50 μm is favorably used. In addition to the independent thin film-shaped materials described above, a separator obtained by forming a composite porous layer containing particles of the inorganic substance described above, on the surface layer of the positive electrode and/or the negative electrode by using a binder made of a resin, can be employed. For example, a separator in which alumina particles having a 90% particle size of less than 1 μm are formed on both surfaces of the positive electrode as porous layers by using a binder of a fluororesin, may be used.

### (Preparation of Non-Aqueous Electrolyte for Secondary Battery)

As the shape of the lithium secondary battery, any form such as a sheet form, a rectangular form, or a cylindrical form can be applied as described above. The mixture (dispersion) containing the positive electrode active substance or the negative electrode active substance is mainly used after being applied (coated) on a current collector, dried, and compressed.

Hereinafter, bottomed cylindrical lithium secondary battery 100 will be taken as an example, and its configuration and a production method thereof will be described with reference to FIG. 2. In a battery having a bottomed cylindrical shape, since the external surface area relative to the power generating element to be charged is small, it is preferable to design the battery such that the Joule heating that is generated due to the internal resistance at the time of charging or discharging is efficiently dissipated to the outside. Furthermore, it is preferable to design the lithium secondary battery such that the filling ratio of a substance having high heat conductivity is increased so as to decrease the temperature distribution inside the battery. FIG. 2 is an example of bottomed cylindrical lithium secondary battery 100. This cell is bottomed cylindrical lithium secondary battery 100 in which positive electrode sheet 14 and negative electrode sheet 16 that are superimposed with separator 12 interposed therebetween, are wound and accommodated in packaging can 18. In addition, reference numeral 20 in the diagram represents an insulating plate, 22 represents an opening-sealing plate, 24 represents a positive electrode current collector, 26 represents a gasket, 28 represents a pressure-sensitive valve body, and 30 represents a current blocking element. Meanwhile, the diagram inside the magnified circle is indicated with varying hatchings in consideration of visibility, but each member corresponds to the overall diagram by the reference numerals.

First, a negative electrode active substance is mixed with a solution prepared by dissolving a binder, a filler and the like that are used as desired in an organic solvent, and thus a negative electrode mixture is prepared in a shiny form or in a paste form. The negative electrode mixture thus obtained is uniformly applied over the entire surface of both sides of a metal core as a current collector, and then the organic solvent is removed to form a negative electrode active substance layer. Furthermore, the laminate (mixture) of the current collector and the negative electrode active substance layer is rolled by using a roll pressing machine or the like to produce a laminate having a predetermined thickness, and thereby, a negative electrode sheet (electrode sheet) is obtained. At this time, the application method for each agent, the drying of applied matter, and the formation method for positive and negative electrodes may conform to the usual method.

In the present embodiment, a cylindrical battery has been explained as an example, but the present invention is not limited to this. For example, positive and negative electrode sheets (mixture) produced by the methods described above are superimposed with a separator interposed therebetween, and then the assembly may be processed directly into a sheet-like battery. Alternatively, a rectangular-shaped battery may be formed by folding the assembly, inserting the assembly into a rectangular can, electrically connecting the can with the sheet, subsequently injecting an electrolyte, and sealing the opening by using an opening-sealing plate.

In any of the embodiments, a safety valve can be used as an opening-sealing plate for sealing the opening. Furthermore, an opening sealing member may be equipped with various safety elements that are conventionally known, in addition to the safety valve. For example, as overcurrent preventing elements, a fuse, a bimetal, a PTC element and the like are favorably used.

Furthermore, as a countermeasure for an increase in the internal pressure of the battery can, a method of making a slit in the battery can, a gasket cracking method, an opening-sealing plate cracking method, or a method of disconnecting from a lead plate can be used in addition to the method of providing a safety valve. Furthermore, a charging machine may be provided with a protective circuit which incorporates a measure for overcharge or overdischarge. Alternatively, the aforementioned protective circuit may be independently connected to the charging machine.

For the can or the lead plate, a metal or an alloy having electrical conductivity can be used. For example, metals such as iron, nickel, titanium, chromium, molybdenum, copper, and aluminum, or alloys thereof are favorably used.

For the welding method that may be used when a cap, a can, a sheet, and a lead plate are welded, any known methods (for example, an electric welding method using a direct current or an alternating current, a laser welding method, an ultrasonic welding method, and the like) can be used. As the sealing agent for sealing an opening, any conventionally known compounds such as asphalt, and mixtures can be used.

### [Use of Non-Aqueous Secondary Battery]

Non-aqueous secondary batteries of the present invention are applied to various applications since the secondary batteries have satisfactory cycling characteristics.

There are no particular limitations on the application embodiment for the non-aqueous secondary battery, but in the case of mounting the non-aqueous secondary battery in electronic equipment, examples of the equipment include notebook computers, pen-input personal computers, mobile personal computers, electronic book players, mobile telephones, cordless phone handsets, pagers, handy terminals, portable facsimiles, portable copying machines, portable printers, headphone stereo sets, video movie cameras, liquid crystal television sets, handy cleaners, portable CDs, mini disc players, electric shavers, transceivers, electronic organizers, calculators, memory cards, portable tape recorders, radios, backup power supplies, and memory cards. Other additional applications for consumer use include automobiles, electromotive vehicles, motors, lighting devices, toys, game players, load conditioners, timepieces, strobes, cameras, and medical devices (pacemakers, hearing aids, shoulder massaging machines, and the like). Furthermore, the non-aqueous secondary battery can be used as various batteries for munition and space batteries. Also, the non-aqueous secondary battery can be combined with a solar cell.

The metal ion that may be used for charge transport in the secondary battery is not particularly limited and it is preferable to use the ion of a metal belonging to Group 1 or 2 of the periodic table. Among them, ions such as lithium ion, sodium ion, magnesium ion, calcium ion and aluminum ion are preferably used. As for the general technical matters of secondary batteries using lithium ions, a lot of literatures and books including the references mentioned at the beginning of the specification are published and referenced therefor. In addition, Journal of Electrochemical Society; Electrochemical Science and Technology (US, 1980, Vol. 127, pp. 2097-2099) and the like can be referenced for the secondary battery using sodium ions. Nature 407, pp. 724-727 (2000) and the like can be referenced for magnesium ion. J. Electrochem. Soc., Vol. 138, 3536 (1991) and the like can be referenced for calcium ion. The present invention is preferably applied to lithium ion secondary batteries because they are widely spread but the present invention also has a desired effect on other articles than the lithium ion secondary batteries and should not be construed as being limited thereto.

### EXAMPLES

Hereinafter, the present invention will be described in more detail with reference to examples, but the present invention is not limited to these examples.

### Example 1/Comparative Example 1

### Preparation of Liquid Electrolyte

Each of the organic typical metal compounds shown in Table 1 was added to a liquid electrolyte of 1M LiPF₆ ethylene carbonate/diethyl carbonate at a volume ratio of 1:1 by the amount described in Table 1 to prepare a test liquid electrolyte, respectively.

### Preparation of 2032-Type Coin Battery

A positive electrode was produced by using an active material: lithium nickel manganese cobalt oxide (LiNi_{1/3}Mn_{1/3}Co_{1/3}O₂) 85% by mass, a conductive assistant: carbon black 7% by mass and a binder: PVDF (polyvinylidene fluoride) 8% by mass, and a negative electrode was produced by using an active material: LTO (lithium titanate) 86% by mass, a conductive assistant: carbon black 6% by mass and a binder: PVDF 8% by mass. A separator was 25 μm thick made of polypropylene. A 2032-type coin battery was produced for each test liquid electrolyte by using the above-mentioned positive and negative electrodes and separator to evaluate the following items. The results are shown in Table 1.

### <Capacity Maintaining Ratio—300 Cycles>

A 2032-type coin battery produced by the method described above was used. In a constant-temperature chamber at 60° C., the battery was subjected to constant current charging at 1 C until the battery voltage reached 4.4 V at 4.0 mA, subsequently to charging at a constant voltage of 4.4 V until the current value reached 0.12 mA or for 2 hours, and then to constant current discharging at 1 C until the battery voltage reached 2.75 V at 4.0 mA. This was defined as one cycle. This cycle was repeated until the number of cycles reached 300 to measure the discharge capacity (mAh) of the 300th cycle.

Discharge capacity maintaining ratio (%)={(Discharge capacity of 300th cycle)/(Discharge capacity of 1st cycle)}×100

### <High-Rate Discharge Characteristics—300 Cycles>

The battery subjected to the cycle test by the above-described method was subjected to constant current charging at 1 C until the battery volt reached 4.4 V at 4.0 mA, and then charged until the current value at the 4.4 V constant voltage reached 0.02 mA to form a full charge condition, and then a quantity of charged electricity was measured. Next, the battery was subjected to constant current discharging at 4 C until the battery volt reached 2.75 V at 16.0 mA, and then a quantity of discharged electricity (mAh) at the time of high-rate discharge was measured.

High-rate discharge efficiency (%)=(Quantity of discharged electricity at 4 C)/(Quantity of charged electricity at full charge)×100

TABLE 1

| | Compound 1 | | Compound 2 | | Capacity | High-rate |
|---|---|---|---|---|---|---|
| | | Addition | | Addition | maintaining | discharge |
| | | amount | | amount | ratio | efficiency |
| Test | | (mol/L) | | (mol/L) | (%/300 times) | (%) |
| 101 | I-1 | 0.07 | | | 85 | 55.3 |
| 102 | I-2 | 0.1 | | | 92 | 57.0 |
| 103 | I-3 | 0.89 | | | 94 | 63.9 |
| 104 | I-4 | 0.5 | | | 90 | 58.5 |
| 105 | I-5 | 0.69 | | | 89 | 62.3 |
| 106 | I-6 | 0.7 | | | 89 | 62.2 |
| 107 | I-7 | 0.45 | | | 92 | 66.2 |
| 108 | I-8 | 0.1 | | | 95 | 61.8 |
| 109 | I-9 | 0.08 | | | 96 | 66.2 |
| 110 | I-2 | 0.05 | I-3 | 0.05 | 98 | 60.8 |
| 111 | I-3 | 0.05 | I-4 | 0.05 | 95 | 61.8 |
| C11 | None | | | | 72 | 46.8 |
| C12 | H-1 | 0.2 | | | 70 | 45.5 |
| C13 | H-2 | 0.2 | | | 76 | 49.4 |
| C14 | 1-1 | 5 | | | Charge failure | |

Nos. beginning with C are Comparative Examples.

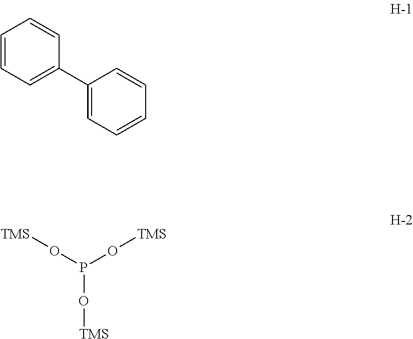 [SMILES: c1ccc(-c2ccccc2)cc1 ; C[Si](C)(C)OP(O[Si](C)(C)C)O[Si](C)(C)C]

The particular organic typical metal compound of the present invention allows effective improvement in cycling characteristics in an extremely small addition amount thereof. In contrast, the effect cannot be achieved by the compounds (H-1, H-2) in Comparative Examples within the same range of addition amount. The superiority of the positive electrode-protective film (SEI) derived from the organic typical metal compound is apparent from these comparisons.

Further, it is understood that by mixing the particular organic typical metal compounds (Examples 110 and 111), better SEI is considered to have been formed, and this allows achievement of more beneficial effects.

### Example 2/Comparative Example 2

### Preparation of 2032-Type Coin Battery

A positive electrode was produced by using an active material: lithium cobalt oxide (LiCoO₂) 85% by mass, a conductive assistant: carbon black 7% by mass and a binder: PVDF (polyvinyl idene fluoride) 8% by mass, and a negative electrode was produced by using an active material: graphite 86% by mass, a conductive assistant: carbon black 6% by mass and a binder: PVDF 8% by mass. A separator was 25 μm thick made of polypropylene. A 2032-type coin battery was produced for each test liquid electrolyte (preparation was similar to Example 1) by using the above-mentioned positive and negative electrodes and separator, and the following items were evaluated with respect to the each test liquid electrolyte. The results are shown in Table 2.

### <Capacity Maintaining Ratio—300 Cycles>

A 2032-type battery produced by the method described above was used. In a constant-temperature a constant-temperature chamber at 60° C., the battery was subjected to constant current charging at 1 C until the battery voltage reached 4.2 V at 4.0 mA, subsequently to charging at a constant voltage of 4.2 V until the current value reached 0.12 mA or for 2 hours, and then to constant current discharging at 1 C until the battery voltage reached 2.75 V at 4.0 mA. This was defined as one cycle. This cycle was repeated until the number of cycles reached 300 to measure the discharge capacity (mAh) of the 300th cycle.

Discharge capacity maintaining ratio (%)={(Discharge capacity of 300th cycle)/(Discharge capacity of 1st cycle)}×100

### <High-Rate Discharge Characteristics-300 Cycles>

The battery subjected to the cycle test by the above-described method was subjected to constant current charging at 1 C until the battery volt reached 4.2 V at 4.0 mA, and then charged until the current value at the 4.2 V constant voltage reached 0.02 mA to form a full charge condition, and then a quantity of charged electricity was measured. Next, the battery was subjected to constant current discharging at 4 C until the battery volt reached 2.75 V at 16.0 mA, and then a quantity of discharged electricity (mAh) at the time of high-rate discharge was measured.

High-rate discharge efficiency (%)=(Quantity of discharged electricity at 4 C)/(Quantity of charged electricity at full charge)×100

TABLE 2

| | | Addition | Capacity | High-rate |
|---|---|---|---|---|
| | | amount | maintaining ratio | discharge |
| Test | Compound 1 | (mol/L) | (%/300 times) | efficiency (%) |
| 201 | I-2 | 0.05 | 85 | 73.1 |
| 202 | I-3 | 0.02 | 82 | 70.5 |
| 203 | I-4 | 0.03 | 89 | 47.5 |
| 204 | I-6 | 0.005 | 85 | 49.1 |
| 205 | I-7 | 0.01 | 86 | 55.0 |
| 206 | I-8 | 0.006 | 86 | 55.0 |
| C21 | None | | 68 | 51.1 |
| C22 | H-1 | 0.21 | 65 | 46.8 |
| C23 | H-1 | 0.015 | 64 | 59.8 |
| C24 | H-2 | 0.25 | 64 | 59.8 |
| C25 | H-2 | 0.025 | 66 | 53.0 |
| C26 | I-1 | 5 | Charge failure | Charge failure |

Nos. beginning with C are Comparative Examples.

From these results, it is understood that the desirable effects of the present invention can be achieved preferably even though the material of the positive electrode is replaced.

Having described our invention as related to the present embodiments, it is our intention that the invention not be limited by any of the details of the description, unless otherwise specified, but rather be construed broadly within its spirit and scope as set out in the accompanying claims.

### REFERENCE SIGNS LIST

C Positive electrode (positive electrode mixture)
   1 Positive electrode conductive material (current collector)
   2 Positive-electrode active material layer
A Negative electrode (negative electrode mixture)
   3 Negative electrode conductive material (current collector)
   4 Negative electrode active material layer
5 Non-aqueous liquid electrolyte
6 Operating means
7 Circuit wiring
9 Separator
10 Lithium ion secondary battery
12 Separator
14 Positive electrode sheet
16 Negative electrode sheet
18 Packaging can which doubles as a negative electrode
20 Insulating plate
22 Opening-sealing plate
24 Positive electrode current collector
26 Gasket
28 Pressure-sensitive valve body
30 Current blocking element
100 Bottomed cylindrical lithium secondary battery

1. A non-aqueous liquid electrolyte for a secondary battery, the non-aqueous liquid electrolyte comprising:
an electrolyte;
an organic typical metal compound; and
an organic solvent, the organic solvent containing the electrolyte and the organic typical metal compound, the organic typical metal compound being contained in the organic solvent in an amount of 1 mol/L or less.

2. The non-aqueous liquid electrolyte for a secondary battery according to claim 1, wherein the organic typical metal compound is a compound represented by the following formula (I): 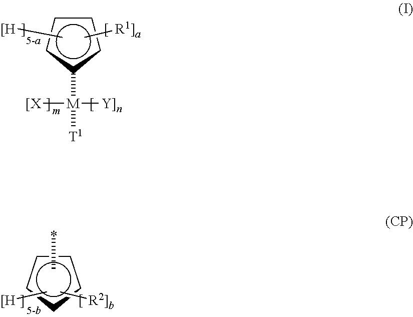
wherein M represents a typical metal element; R¹ represents an alkyl group, an alkenyl group, an alkynyl group, an alkoxy group, a thioalkoxy group, an amino group, an alkylamino group, an amide group, an acyloxy group, a cyano group, a carboxyl group, a group containing a carbonyl group, a group containing a sulfonyl group, a phosphinyl group, or a halogen atom; R¹ may form an aliphatic ring or an aromatic ring;
a represents an integer of from 0 to 5;
X and Y each independently represent an alkyl group, an alkoxy group, a thioalkoxy group, an alkylamino group, a sulfonate group, a halogen atom, an aryl group, or a heteroaryl group;
m and n are integers satisfying 0≦m+n≦3;
T¹ represents a hydrogen atom, a methyl group, a n-butyl group, an alkylamino group, or a group represented by formula (Cp); R² in formula (Cp) has the same meaning as R¹; * means an atomic bonding; b represents an integer of from 0 to 5; and R¹ and R² may be linked to each other.

3. The non-aqueous liquid electrolyte for a secondary battery according to claim 2, wherein the compound represented by formula (I) is a compound represented by the following formula (Icp): (Icp): 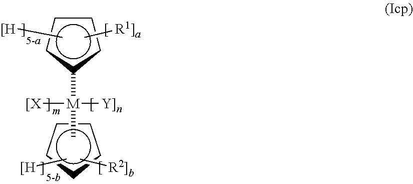
wherein M, R¹, R², a, b, X, Y, m and n have the same meanings as those in formula (I).

4. The non-aqueous liquid electrolyte for a secondary battery according to claim 1, wherein the organic typical metal compound has a partial structure represented by formula (II):
M-NR³R⁴ formula (II)
wherein M represents a typical metal element; N represents a nitrogen atom; R³ and R⁴ each independently represent a hydrogen atom, an alkyl group, an alkenyl group, an alkynyl group, an aryl group, a heteroaryl group, an alkylsilyl group, or a halogen atom; R³ and R⁴ may form an aliphatic ring or an aromatic ring; and R³ and R⁴ may be linked to each other.

5. The non-aqueous liquid electrolyte for a secondary battery according to claim 4, wherein R³ and R⁴ each are an alkyl group or an alkylsilyl group.

6. The non-aqueous liquid electrolyte for a secondary battery according to claim 4, wherein the compound represented by formula (II) is a compound represented by the following formula (IIa) or (IIb):
M-(NR³R⁴)_{q} formula (IIa)
(NR³R⁴)_{q1}-M(-NR³R⁴-)_{q2}M-(NR³R⁴)_{q3} formula (IIb)
wherein M, R³ and R⁴ have the same meanings as those in formula (II); q represents an integer of from 2 to 4; and q1 to q3 each independently represent 2 or 3.

7. The non-aqueous liquid electrolyte for a secondary battery according to claim 3, wherein the compound represented by formula (Icp) is a compound represented by the following formula (Ia): 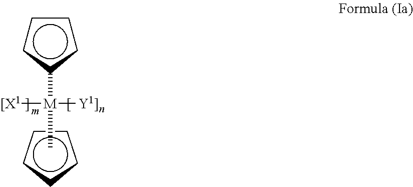
wherein X¹ and Y¹ each independently represent an alkoxy group, a thioalkoxy group, or an alkylamino group; and M, m and n have the same meanings as those in formula (I).

8. The non-aqueous liquid electrolyte for a secondary battery according to claim 7, wherein, in formula (Ia), m is 0, and n is 0 or 2.

9. The non-aqueous liquid electrolyte for a secondary battery according to claim 1, wherein the organic typical metal compound is contained in an amount of 0.5 mol/L or less and 0.0001 mol/L or more.

10. The non-aqueous liquid electrolyte for a secondary battery according to claim 1, wherein a central metal in the organic typical metal compound is Al, Si, Sn, or Mg.

11. The non-aqueous liquid electrolyte for a secondary battery according to claim 1, further comprising a polymerizable compound.

12. A non-aqueous secondary battery, comprising:
a positive electrode;
a negative electrode; and
the non-aqueous liquid electrolyte for a secondary battery according to claim 1.

13. The non-aqueous secondary battery according to claim 12, wherein an active material of the positive electrode is a transition metal oxide.
